(19) United States
(12) Patent Application Publication
(10) Pub. No.: US 2014/0146759 A1
(43) Pub. Date: May 29, 2014

(54) SYSTEM, METHOD AND APPARATUS FOR ADDRESSING MISMATCH OF RADIO RESOURCE CONTROL STATUS IN WIRELESS COMMUNICATION SYSTEM

(71) Applicant: Samsung Electronics Co., Ltd., Suwon-si (KR)

(72) Inventors: Seung-Moo CHO, Namyangju-si (KR); Su-Young PARK, Uiwang-si (KR)

(73) Assignee: Samsung Electronics Co., Ltd., Suwon-si (KR)

(21) Appl. No.: 14/056,455

(22) Filed: Oct. 17, 2013

(30) Foreign Application Priority Data
Nov. 23, 2012 (KR) 10-2012-0133480

(51) Int. Cl. H04L 5/00

(52) U.S. Cl. CPC H04L 5/0096
USPC 370/329

(57) ABSTRACT

A method for addressing Radio Resource Control (RRC) status mismatch in a wireless communication system is provided. The method includes receiving, at a terminal, a paging message comprising temporary subscriber identity information, when receiving the paging message comprising the temporary subscriber identity information, determining whether the terminal is in a Radio Resource Control (RRC) connected mode, and if it is determined that the terminal is in the RRC connected mode, performing RRC connection reestablishment.

### CROSS-REFERENCE TO RELATED APPLICATION(S)

This application claims the benefit under 35 U.S.C. §119(a)of a Korean patent application filed on Nov. 23, 2012, in the Korean Intellectual Property Office and assigned Serial No. 10-2012-0133480, the entire disclosure of which is hereby incorporated by reference.

### TECHNICAL FIELD

The present disclosure relates to a wireless communication system. More particularly, the present disclosure relates to a system, a method, and an apparatus for addressing Radio Resource Control (RRC) status mismatch.

### BACKGROUND

Wireless communication systems are advancing to providing high-quality and high-speed multimedia services. The 3^{rd} Generation Partnership Project (3GPP) standardization group develops a Long Term Evolution (LTE) communication system, to overcome technical limits of 3G mobile communication systems based on Wideband Code Division Multiple Access (WCDMA).

In the LTE communication system, a User Equipment (UE) is connected to a core network over an access network for network registration and data transfer. The 3GPP defines link connection between an evolved Node B (eNodeB) of the access network and the UE, as a Radio Resource Control (RRC) connected mode. In the RRC connected mode, the eNodeB assigns a Call-Radio Network Temporary Identity (C-RNTI) to the UE, and schedules radio resources by considering channel condition of the UE, buffer data amount, and power headroom.

Paging in the LTE communication system is conducted when there is packet data or Circuit Switched (CS) voice destined for the UE, and when System Information (SI) is changed. When the SI is changed, the paging is transmitted to the UE over the network in both an RRC idle mode and the RRC connected mode of the UE. A paging message for delivering Packet Switched (PS) data and CS voice includes System Architecture Evolution (SAE)-Temporary Mobile Station Identity (S-TMSI) information, which is sent when the UE is in the RRC idle mode.

In the meantime, Evolved-Universal Terrestrial Radio Access Network (E-UTRAN) standard of the 3GPP does not describe an exception when the UE receives the paging including its S-TMSI in the RRC connected mode. That is, when the paging message including the S-TMSI of the UE is sent over the network, the network can determine the UE in the RRC idle mode. At this time, when the UE stays in the RRC connected mode, the UE ignores the received paging message. In result, the UE cannot normally receive the PS data and the CS voice. When the UE triggers an uplink data transfer event, the RRC status mismatch between the UE and the network continues until a scheduling request is sent to the eNodeB and RRC connection reestablishment is conducted.

Thus, what are needed to address the above problem is a method and an apparatus for addressing the RRC status mismatch in the LTE communication system.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address the above-mentioned problems and/or disadvantages and to provide at least the advantages described below. Accordingly, an aspect of the present disclosure is to provide a system, a method, and an apparatus for addressing Radio Resource Control (RRC) status mismatch in aLong Term Evolution (LTE) communication system.

Another aspect of the present disclosure is to provide a system, a method, and an apparatus for normally receiving Packet Switched (PS) data and Circuit Switched (CS) voice when a User Equipment (UE) in an RRC connected mode receives a paging message including its System Architecture Evolution (SAE)-Temporary Mobile Station Identity (S-TMSI) from an evolved Node B (eNodeB).

In accordance with an aspect of the present disclosure, an operating method in a wireless communication system is provided. The method includes receiving, at a terminal, a paging message including temporary subscriber identity information, when receiving the paging message comprising the temporary subscriber identity information, determining whether the terminal is in an RRC connected mode, and if it is determined that the terminal is in the RRC connected mode, performing RRC connection reestablishment.

In accordance with another aspect of the present disclosure, an operating method of a base station for addressing RRC status mismatch in a wireless communication system is provided. The method includes sending, at the base station, a paging message comprising temporary subscriber identity information to a terminal, and when the terminal is in an RRC connected mode, performing RRC connection reestablishment with the terminal

In accordance with yet another aspect of the present disclosure, an electronic device is provided. The device includes a receiver configured to receive a paging message comprising temporary subscriber identity information, and a controller configured to, when receiving the paging message comprising the temporary subscriber identity information, determine whether the terminal is in an RRC connected mode and to perform RRC connection reestablishment if it is determined that the terminal is in the RRC connected mode.

In accordance with still another aspect of the present disclosure, an apparatus of a base station for addressing RRC status mismatch in a wireless communication system is provided. The apparatus includes a transmitter configured to send a paging message comprising temporary subscriber identity information to a terminal, and a controller configured to, when the terminal is in an RRC connected mode, performing RRC connection reestablishment with the terminal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a Long Term Evolution (LTE) communication system according to an embodiment of the present disclosure;

FIG. 2 illustrates a control plane of a radio interface protocol between a User Equipment (UE) and an Evolved-Universal Terrestrial Radio Access Network (E-UTRAN) based on 3^{rd} Generation Partnership Project (3GPP) radio access network standard according to an embodiment of the present disclosure;

FIG. 3 illustrates Radio Resource Control (RRC) connection setup in the LTE communication system according to an embodiment of the present disclosure;

FIG. 4 illustrates RRC connection reestablishment in the LTE communication system according to an embodiment of the present disclosure;

FIG. 5 illustrates operations of the UE for addressing RRC status mismatch in the LTE communication system according to an embodiment of the present disclosure;

FIG. 6 illustrates operations of an evolved Node B (eNodeB) for addressing the RRC status mismatch in the LTE communication system according to an embodiment of the present disclosure; and

FIG. 7 illustrates an apparatus for addressing the RRC status mismatch in the LTE communication system according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Various embodiments of the present disclosure provide a method and an apparatus for addressing Radio Resource Control (RRC) status mismatch in a wireless communication system.

Hereinafter, a User Equipment (UE) has substantially the same meaning as a mobile station or a terminal, and an evolved Node B (eNodeB) or a Node B has substantially the same meaning as a base station.

When the UE receives a paging message including its System Architecture Evolution (SAE)-Temporary Mobile Station Identity (S-TMSI) in an RRC connected mode, the UE cannot determine RRC status mismatch between a network and the UE. At this time, the UE cannot switch from the RRC connected mode to an RRC idle state by itself When receiving the paging message including the S-TMSI in the RRC connected mode because of a network fault, the UE adjusts the RRC status of the UE and the network to the RRC connected mode by setting a value Reestablishment Cause to a value other Failure and performing RRC connection reestablishment.

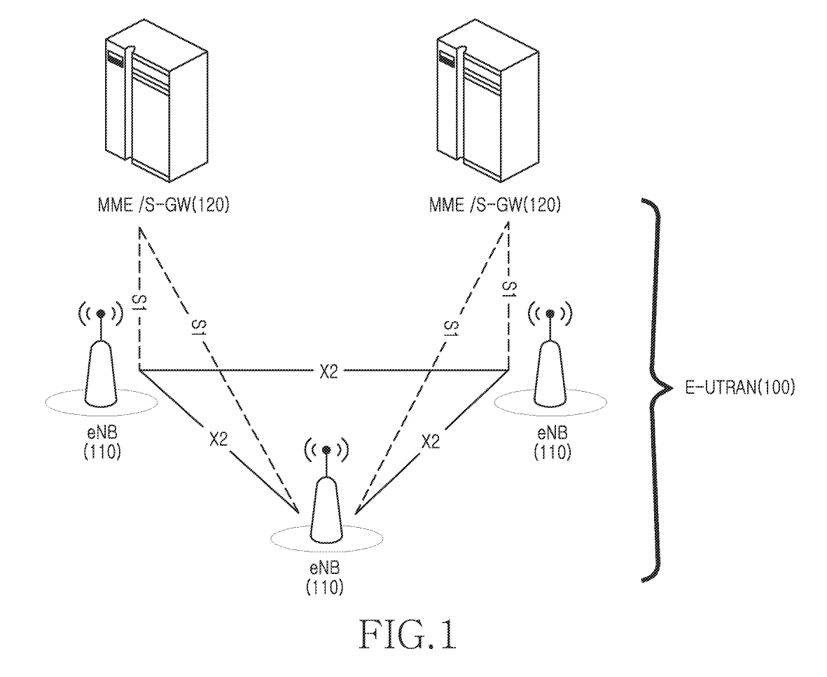

FIG. 1 depicts a network architecture of a Long Term Evolution (LTE) communication system according to an embodiment of the present disclosure. The LTE system can be referred to as an Evolved-Universal Mobile Telecommunications System (E-UMTS). The E-UMTS system is evolved from the existing UMTS system, and the 3^{rd} Generation Partnership Project (3GPP) is working on its basic standardization.

The LTE network is largely divided into an Evolved-Universal Terrestrial Radio Access Network (E-UTRAN) and a Core Network (CN). The E-UTRAN 100 includes a UE (not shown), an eNodeB (eNB) 110, and a Mobility Management Entity (MME)/Serving Gateway (S-GW) or an Access Gateway (AG) 120 disposed at an end of the network and connected to an external network. The AG 120 may be divided into a part for processing user traffic and a part for processing control traffic. The AG for processing new user traffic and the AG for processing the control traffic may communicate with each other using a new interface. One eNodeB 110 can cover one or more cells. The eNodeB 110 may use the interface for sending the user traffic or the control traffic. The CN (not shown) may include the AG 120 and a node (not shown) for user registration of other UE. An interface for dividing the E-UTRAN and the CN may be used.

Radio interface protocols between the UE and the network can include a Layer 1 (L1), a Layer 2 (L2), and a Layer 3 (L3), based on three lower layers of the Open System Interconnection (OSI) model of the related art. A physical layer of the L1 provides an information transfer service using a physical channel, and the RRC of the L3 controls radio resources between the UE and the network. For doing so, the RRC layer exchanges RRC messages between the UE and the network. The RRC layer may be distributed to network nodes such as eNodeB 110 and AG 120, or used only in one of the eNodeB 110 or the AG 120. An eNB 110 may communicate with other eNB 110 nodes via an X2 protocol interface, and may communicate with AG 120 via an S1 interface.

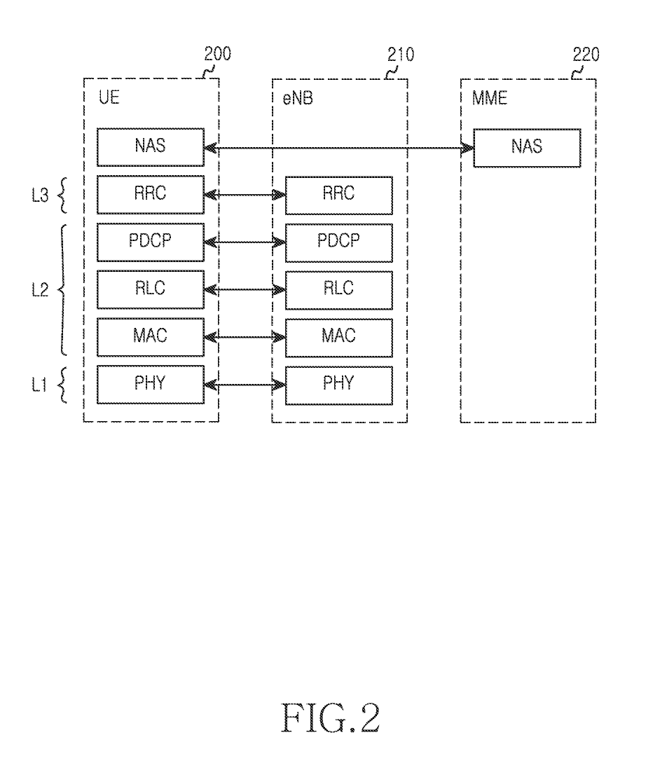

FIG. 2 depicts a control plane of the radio interface protocol between the UE 200 and the E-UTRAN eNB 210 and MME 220 based on the 3GPP radio access network standard according to an embodiment of the present disclosure. The radio interface protocol of FIG. 2 horizontally includes at least a physical layer, a data link layer, and a network layer, and vertically includes a user plane for sending data information and the control plane for sending a control signaling. The protocol layers of FIG. 2 can be divided into the L1, the L2, and the L3 based on three lower layers of the OSI model of the related art.

The physical layer (PHY) of the L1 provides the information transfer service to the higher layer using the physical channel. The physical layer is connected to the higher Medium Access Control (MAC) layer through a transport channel. Data is sent between the MAC layer and the physical layer through the transport channel. The physical channel delivers data between different physical layers, that is, between the physical layers of a sender and a receiver.

The MAC of the L2 provides the service to a higher Radio Link Control (RLC) layer through a logical channel. The RLC layer of the L2 supports reliable data transfer. Functions of the RLC layer may be implemented as functions blocks in the MAC. IN this case, the RLC layer may be omitted. The Packet Data Convergence Protocol (PDCP) layer of the L2 performs header compression to reduce an Internet Protocol (IP) header size containing relatively large and unnecessary control information, so as to efficiently send an IP packet in a radio section of narrow bandwidth such as IPv4 or IPv6. The PDCP layer can apply integrity protection and ciphering to the control signal such as RRC signal and/or the user data.

The highest RRC layer of the L3 is defined only in the control plane, and controls the logical channel, the transport channel, and the physical channels in relation to Radio Bearer (RB) configuration, reconfiguration, and release. In so doing, the RB indicates the service provided by the L2 to send the data between the UE and the UTRAN. When the RRC connection exists between the RRC layer of the UE and the RRC layer of the radio network, the UE stays in the RRC connected mode. Otherwise, the UE is in the RRC idle mode.

A Non-Access Stratum (NAS) layer above the RRC layer performs session management and mobility management.

A downlink channel (not shown) for delivering data from the network to the UE includes a Broadcast Channel (BCH) for sending system information, a Paging Channel (PCH) for sending the paging message, and a downlink Shared Channel (SCH) for sending user traffic or a control message. Downlink multicast, broadcasting service traffic, or the control message may be sent through the downlink SCH or a separate downlink Multicast Channel (MCH). Meanwhile, an uplink channel for delivering data from the UE to the network includes a Random Access Channel (RACH) for sending an initial control message, and an uplink SCH for sending the user traffic or the control message.

The eNB manages the radio resources of the one or more cells. One cell is assigned one bandwidth, such as 1.25 megahertz (MHz), 2.5 MHz, 5 MHz, 10 MHz, or 20 MHz, to provide the downlink or uplink transport service to multiple UEs. In so doing, different cells can provide different bandwidths. The cells may be geographically overlapped using multiple frequencies. The eNB informs the UE of basic information for the network access using System Information (SI). The SI includes necessary information of the UE for accessing the eNB. Accordingly, the UE needs to receive SI messages before accessing the eNB and to hold the latest SI. Since every UE in one cell should know the SI, the eNB periodically sends the SI.

The logical channel (not shown) above the transport channel and mapped to the transport channel includes a Broadcast Channel (BCCH), a Paging Control Channel (PCCH), a Common Control Channel (CCCH), a Multicast Control Channel (MCCH), a Multicast Traffic Channel (MTCH), a Dedicated Control Channel (DDCH), and so on.

The physical layer includes a plurality of subframes in the time domain (not shown) and a plurality of subcarriers in the frequency domain (not shown). Herein, one subframe includes a plurality of symbols and a plurality of subcarriers in the time domain. One subframe includes a plurality of resource blocks. One resource block includes a plurality of symbols and a plurality of subcarriers. The subframe includes a Physical Downlink Control Channel (PDCCH) corresponding to the L1/L2 control channel, and a Physical Downlink Shared Channel (PDSCH) corresponding to the downlink SCH and PCH. To transport them, particular subcarriers of particular symbols (e.g., the first symbol) of the corresponding subframe can be used. One resource block is referred to as a slot and is 0.5 ms in duration. A Transmission Time Interval (TTI) being a unit time for the data transport is 1 ms corresponding to the single subframe.

The transmission and reception of the paging message is now explained. When receiving the paging message containing a paging record including a paging cause and UE identity, the UE can perform Discontinuous Reception (DRX) to conserve its power. For doing so, the network generates a plurality of paging occasions at time intervals called paging DRX cycles so that a particular UE can obtain the paging message by periodically receiving only at a particular paging occasion. The UE does not listen to the paging channel and can sleep to conserve the power during other time than the particular paging occasion. One paging occasion corresponds to one TTI.

The eNB and the UE can indicate whether the paging message is present, using a Paging Indicator (PI) with a particular value indicating the paging message transmission. By defining a particular identity (e.g., Paging Indicator-Radio Network Temporary Identity (PI-RNTI)) as the PI, the eNB can inform the UE of the paging information transmission. For example, the UE wakes up per DRX cycle and receives one subframe to detect the paging message. When the L1/L2 control channel PDCCH of the received subframe contains the PI-RNTI, the UE can obtain that the PDSCH of the corresponding subframe contains the paging message. When the paging message contains the UE identity (e.g., an International Mobil Subscriber Identity (IMSI)), the UE responds to the eNB (e.g., the RRC connection) and receives the service.

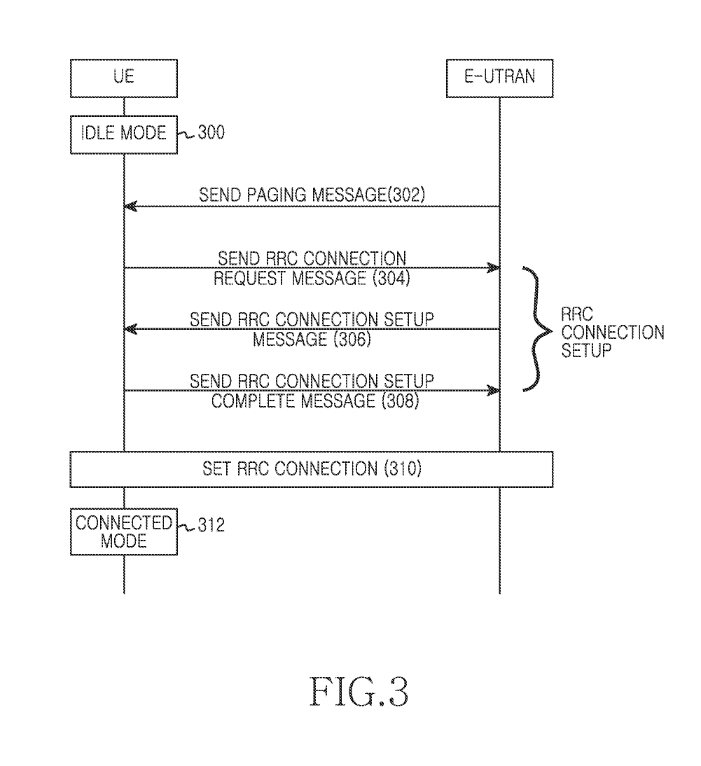

FIG. 3 depicts the RRC connection setup in the LTE communication system according to an embodiment of the present disclosure.

Referring to FIG. 3, the E-UTRAN sends a paging message to the UE at operation 302. When the UE in the idle mode at operation 300 performs the RRC connection to make a call or to respond to the paging message at operation 302 of the E-UTRAN, the UE sends an RRC connection request message to the E-UTRAN at operation 304. The RRC connection request message includes the initial UE identity (e.g., S-TMSI) and the RRC establishment cause. The initial UE identity indicates a UE unique identity for identifying the corresponding UE anywhere in the world. There are several RRC establishment causes, for example, the call trial or the response to the paging. The UE drives a timer concurrently with the sending of the RRC connection request message. If the UE does not receive an RRC connection setup message or an RRC connection reject message from the E-UTRAN before the time expires, the UE resends the RRC connection request message. A maximum transmission time of the RRC connection request message is limited to a particular value.

The E-UTRAN receiving the RRC connection request message from the UE accepts the RRC connection request of the UE at operation 304 when the radio resource is sufficient, and sends the RRC connection setup message being a response message to the UE at operation 306.

The UE receiving the RRC connection setup message of operation 306 sends an RRC connection setup complete message to the E-UTRAN at operation 308. In so doing, when successfully sending the RRC connection setup message at operation 308, the UE sets the RRC connection with the E-UTRAN at operation 310 and enters an RRC connection mode at operation 312.

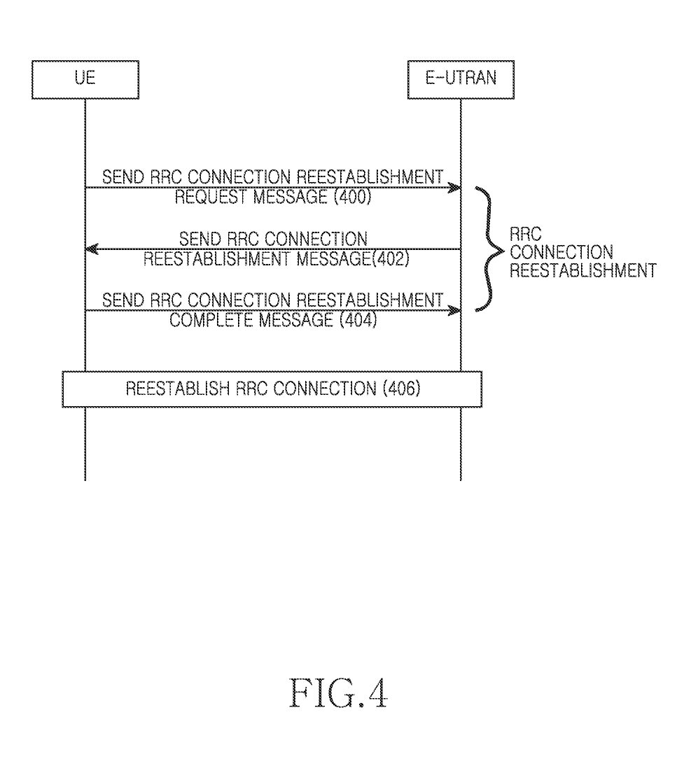

FIG. 4 depicts the RRC connection reestablishment in the LTE communication system according to an embodiment of the present disclosure.

Referring to FIG. 4, when a radio link failure is detected and a handover fails between the UE and the E-UTRAN eNB and when the paging message including the S-TMSI is received in the RRC connected mode, the UE sends an RRC connection reestablishment request message at operation 400.

The RRC connection reestablishment request message includes a ReestabUE-identity (e.g., C-RNTI, PhysCellID, shortMAC I) and a Reestablishment cause. The Reestablishment cause includes link connection failure, handover failure, and other Failure (e.g., the UE receives the paging message including its S-TMSI in the RRC connected mode and thus the RRC status mismatches).

The E-UTRAN reconfigures a Signaling Radio Bearer (SRB) and sends the RRC connection reestablishment message to the UE at operation 402. The SRB for the RRC connection reestablishment message is SRBO and the message transmission uses Transparent Mode (TM) RLC.

According to the RRC connection reestablishment message, the UE reconfigures SRB1 using Acknowledge Mode (AM) RLC and sends an RRC connection reestablishment complete message using the reconfigured SRB1 to the E-UTRAN at operation 404. The SRB for the RRC connection reestablishment complete message is SRB1 and the message transmission uses AM RLC. When the RRC connection reestablishment between the UE and the E-UTRAN is completed at operation 406, the SRB1 is used to send a next RRC message.

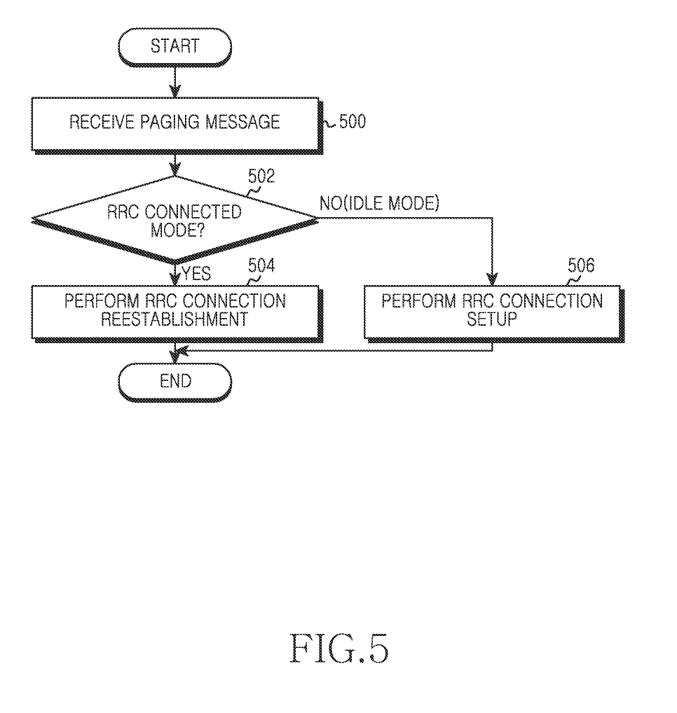

FIG. 5 is a flowchart of operations of the UE for addressing the RRC status mismatch in the LTE communication system according to an embodiment of the present disclosure.

Referring to FIG. 5, the UE in the RRC connected mode receives the paging message including its S-TMSI from the E-UTRAN at operation 500. Although the UE is in the RRC connected mode, the network can determine the UE in the RRC idle mode.

At operation 502, the UE determines whether it is in the RRC connected mode. In the RRC connected mode, the UE performs the RRC connection reestablishment of FIG. 4 at operation 504.

By contrast, if the UE determines it is in the RRC idle mode at operation 502, the UE performs the RRC connection setup of FIG. 3 at operation 506.

Next, the UE finishes this process.

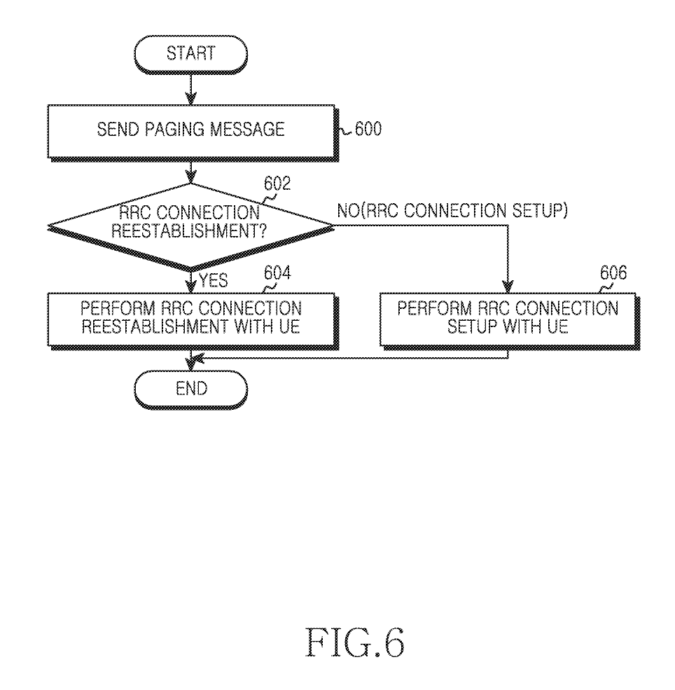

FIG. 6 is a flowchart of operations of the eNodeB for addressing the RRC status mismatch in the LTE communication system according to an embodiment of the present disclosure.

Referring to FIG. 6, when the SI of the UE is changed or there is the PS data or the CS voice destined for the UE, the eNB sends the paging message including the S-TMSI to the UE at operation 600. Although the UE is in the RRC connected mode, the network can determine the UE in the RRC idle mode.

When it is determined that the UE is in the RRC connected mode and receives the paging message including the S-TMSI for the PS data or CS voice transport at operation 602, the eNB performs the RRC connection reestablishment of FIG. 4 with the UE at operation 604.

When it is determined that the UE is in the RRC idle mode and receives the paging message including the S-TMSI for the PS data or CS voice transport at operation 602, the eNB performs the RRC connection setup of FIG. 3 with the UE at operation 606.

The eNB then finishes this process.

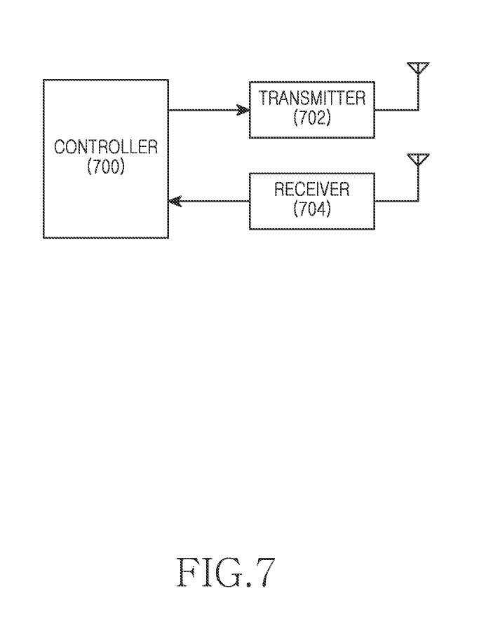

FIG. 7 is a block diagram of an apparatus for addressing the RRC status mismatch in the LTE communication system according to an embodiment of the present disclosure.

Referring to FIG. 7, the UE or the eNB includes a controller 700, a transmitter 702, and a receiver 704.

Traffic data for a plurality of data streams is provided from a data source (not shown) to the controller 700.

In various implementations, each data stream is transmitted over a transmit antenna. The transmitter 702 formats, encodes, and interleaves the traffic data of the data stream based on a particular coding scheme selected for the data stream so as to provide the encoded data.

The encoded data of the data stream can be multiplexed together with pilot data using Orthogonal Frequency Division Multiplexing (OFDM). The pilot data is a known data pattern of the related art which is processed in a known fashion, and can be used in a receiver system to estimate the channel response. Next, the pilot and the encoded data multiplexed for the data stream are modulated (e.g., mapped to symbols) based on a particular selected modulation scheme (e.g., Binary Phase Shift Keying (BPSK), Quadrature Phase Shift Keying (QPSK), M-ary Phase Shift Keying (M-PSK), or M-Quadrature Amplitude Modulation (M-QAM)) with respect to the data stream in order to provide the modulation symbols. A data rate, the coding, and the modulation of the data stream can be determined by instructions executed by the controller 700. A memory (not shown) can store a program code, data, and other information used by the controller 700 and the other components.

The transmitter 702 can additionally process the modulation symbols of every data stream (e.g., for the OFDM), and the modulated signals are transmitted over the antenna.

The receiver 704 receives and processes the symbol stream to provide one or more analog signals, and additionally adjusts (e.g., amplifies, filters, and up-converts) the analog signals to provide the modulated signal suitable for the transmission over the channel.

The received signal is received at a receive antenna and forwarded to the receiver 704. The receiver 704 adjusts (e.g., filters, amplifies, and down-converts) the received signal, digitizes the adjusted signal to provide samples, and additionally processes the samples to provide symbol streams.

Next, the receiver 704 receives and processes the symbol streams based on a particular receiver processing scheme to provide the symbol streams. Next, the receiver 704 demodulates, de-interleaves, and decodes the detected symbol streams to recover the traffic data of the data stream. The processing of the receiver 704 is complementary to the processing of the transmitter 702.

The controller 700 of the UE controls the operations to address the RRC status mismatch. For example, the UE in the RRC connected mode receives the paging message including its S-TMSI from the E-UTRAN through the receiver 704. The controller 700 determines whether it is in the RRC connected mode. In the RRC connected mode, the controller 700 performs the RRC connection reestablishment of FIG. 4. In the RRC idle mode, the controller 700 performs the RRC connection setup of FIG. 3.

When the SI of the UE is changed or there is the PS data or the CS voice destined for the UE, the controller 700 of the eNB sends the paging message including the S-TMSI to the UE. When the UE in the RRC connected mode receives the paging message including the S-TMSI for the PS data or CS voice transport, the controller 700 performs the RRC connection reestablishment of FIG. 4 with the UE. By contrast, when the UE in the RRC idle mode receives the paging message including the S-TMSI for the PS data or CS voice transport, the controller 700 performs the RRC connection setup of FIG. 3 with the UE.

The memory can store the program code, the data, and other information used by the controller 700 and the other components.

The transmit message is processed, modulated, adjusted, and transmitted by the transmitter 702 which receives the traffic data of the multiple data streams from the data source. The received message is received over the antenna, adjusted by the receiver 704, demodulated, and processed.

A single component can provide the functions of two or more of the components of the apparatus.

In various implementations, the transmit channels can be divided into the DownLink (DL) and the UpLink (UL). The DL transmit channels can include the BCH, a DL-Shared Data Channel (SDCH), and the PCH. The PCH is broadcast all over the cell and mapped to PHY resources available to other control/traffic channels. The UL transmit channels can include the RACH, a Request Channel (REQCH), a UL-SDCH, and a plurality of PHY channels. The PHY channels can include a set of DL channels and UL channels.

The DL PHY channels can include a Common Pilot Channel (CPICH), a Synchronization Channel (SCH), the CCCH, a Shared DL Control Channel (SDCCH), a Multicast Control Channel (MCCH), a Shared UL Assignment Channel (SUACH), an Acknowledgement Channel (ACKCH), a DL-Physical Shared Data Channel (PSDCH), a UL Power Control Channel (UPCCH), a Paging Indicator Channel (PICH), and a Load Indicator Channel (LICH).

The UL PHY channels can include a Physical Random Access Channel (PRACH), a Channel Quality Indicator Channel (CQICH), the ACKCH, an Antenna Subset Indicator Channel (ASICH), a Shared Request Channel (SREQCH), a UL-Physical Shared Data Channel (PSDCH), and/or a Broadband Pilot Channel (BPICH).

The above-described methods according to the present disclosure can be implemented in hardware or software alone or in combination.

For software, a computer-readable storage medium containing one or more programs (software modules) can be provided. One or more programs stored to the computer-readable storage medium are configured for execution of one or more processors of an electronic device. One or more programs include instructions making the electronic device execute the methods according to the various embodiments as described in the claims and/or the specification of the present disclosure.

Such programs (software module, software) can be stored to a random access memory, a non-volatile memory including a flash memory, a Read Only Memory (ROM), an Electrically Erasable Programmable ROM (EEPROM), a magnetic disc storage device, a compact disc ROM, Digital Versatile Discs (DVDs) or other optical storage devices, and a magnetic cassette. Alternatively, the programs can be stored to a memory combining part or all of those recording media. A plurality of memories may be equipped.

The programs can be stored to an attachable storage device of the electronic device accessible over the communication network such as Internet, Intranet, Local Area Network (LAN), Wide LAN (WLAN), or Storage Area Network (SAN), or a communication network by combining the networks. The storage device can access the electronic device through an external port.

A separate storage device in the communication network can access a portable electronic device.

As set forth above, when receiving the paging message including the S-TMSI from the eNB in the RRC connected mode, the UE performs the RRC connection reestablishment, to thus address the RRC status mismatch.

In addition, when the UE in the RRC connected mode receives the paging message including its S-TMSI from the eNB, the RRC status mismatch is addressed to thus normally receive the PS data and the CS voice.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A operating method in a wireless communication system, the method comprising:
receiving, at a terminal, a paging message comprising temporary subscriber identity information;
when receiving the paging message comprising the temporary subscriber identity information, determining whether the terminal is in a Radio Resource Control (RRC) connected mode; and
if it is determined that the terminal is in the RRC connected mode, performing RRC connection reestablishment.

2. The method of claim 1, wherein the performing of the RRC connection reestablishment comprises:
sending an RRC connection reestablishment request message to a base station;
receiving an RRC connection reestablishment message from the base station in response to the RRC connection reestablishment request message; and
reconfiguring a Signaling Radio Bearer (SRB) according to the RRC connection reestablishment message, and sending an RRC connection reestablishment complete message to the base station.

3. The method of claim 1, further comprising:
if it is determined that the terminal is in an RRC idle mode, performing RRC connection setup.

4. The method of claim 3, wherein the performing of the RRC connection setup comprises:
sending an RRC connection request message to a base station;
receiving an RRC connection setup message from the base station in response to the RRC connection request message; and
sending an RRC connection setup complete message to the base station in response to the RRC connection setup message.

5. The method of claim 1, wherein the temporary subscriber identity information comprises a System Architecture Evolution (SAE)-Temporary Mobile Station Identity (S-TMSI).

6. The method of claim 1, wherein the wireless communication system comprises a Long Term Evolution (LTE) system.

7. An operating method of a base station for addressing a Radio Resource Control (RRC) status mismatch in a wireless communication system, the method comprising:
sending, at the base station, a paging message comprising temporary subscriber identity information to a terminal; and
when the terminal is in an RRC connected mode, performing RRC connection reestablishment with the terminal

8. The method of claim 7, wherein the performing of the RRC connection reestablishment comprises:
receiving an RRC connection reestablishment request message from the terminal;
reconfiguring a Signaling Radio Bearer (SRB) and sending an RRC connection reestablishment message to the terminal in response to the RRC connection reestablishment request message; and
receiving an RRC connection reestablishment complete message from the terminal in response to the RRC connection reestablishment message.

9. The method of claim 7, further comprising:
when the terminal is in an RRC idle mode, performing RRC connection setup.

10. The method of claim 9, wherein the performing of the RRC connection setup comprises:
receiving an RRC connection request message from the terminal;
sending an RRC connection setup message to the terminal in response to the RRC connection request message; and
receiving an RRC connection setup complete message from the terminal in response to the RRC connection setup message.

11. The method of claim 7, wherein the temporary subscriber identity information comprises a System Architecture Evolution (SAE)-Temporary Mobile Station Identity (S-TMSI).

12. The method of claim 7, wherein the wireless communication system comprises a Long Term Evolution (LTE) system.

13. An electronic device, the device comprising:
a receiver configured to receive a paging message comprising temporary subscriber identity information; and
a controller configured to, when receiving the paging message comprising the temporary subscriber identity information, determine whether the terminal is in an RRC connected mode and to perform RRC connection reestablishment if it is determined that the terminal is in the RRC connected mode.

14. The device of claim 13, wherein the controller is configured to send an RRC connection reestablishment request message to a base station, to receive an RRC connection reestablishment message from the base station in response to the RRC connection reestablishment request message, to reconfigure a Signaling Radio Bearer (SRB) according to the RRC connection reestablishment message, and to send an RRC connection reestablishment complete message to the base station.

15. The device of claim 13, wherein, if the terminal is in an RRC idle mode, the controller is configured to perform RRC connection setup.

16. The device of claim 15, wherein the controller is configured to send an RRC connection request message to a base station, to receive an RRC connection setup message from the base station in response to the RRC connection request message, and to send an RRC connection setup complete message to the base station in response to the RRC connection setup message.

17. The device of claim 13, wherein the temporary subscriber identity information comprises a System Architecture Evolution (SAE)-Temporary Mobile Station Identity (S-TMSI).

18. The device of claim 13, wherein the wireless communication system comprises a Long Term Evolution (LTE) system.

19. An apparatus of a base station for addressing a Radio Resource Control (RRC) status mismatch in a wireless communication system, the apparatus comprising:
a transmitter configured to send a paging message comprising temporary subscriber identity information to a terminal; and
a controller configured to, when the terminal is in an RRC connected mode, perform RRC connection reestablishment with the terminal.

20. The apparatus of claim 19, wherein the controller is configured to receive an RRC connection reestablishment request message from the terminal, to reconfigure a Signaling Radio Bearer (SRB), to send an RRC connection reestablishment message to the terminal in response to the RRC connection reestablishment request message, and to receive an RRC connection reestablishment complete message from the terminal in response to the RRC connection reestablishment message.

21. The apparatus of claim 19, wherein, when the terminal is in an RRC idle mode, the controller is configured to perform RRC connection setup.

22. The apparatus of claim 21, wherein the controller is configured to receive an RRC connection request message from the terminal, to send an RRC connection setup message to the terminal in response to the RRC connection request message, and to receive an RRC connection setup complete message from the terminal in response to the RRC connection setup message.

23. The apparatus of claim 19, wherein the temporary subscriber identity information comprises a System Architecture Evolution (SAE)-Temporary Mobile Station Identity (S-TMSI).

24. The apparatus of claim 19, wherein the wireless communication system comprises a Long Term Evolution (LTE) system.
